(19) United States
(12) Patent Application Publication
(10) Pub. No.: US 2009/0017182 A1
(43) Pub. Date: Jan. 15, 2009

(54) METHOD OF IMPROVING FLAVOR OF SOYBEAN PROTEIN-GLUCOMANNAN JELLY

(76) Inventor: Michihide Akita, Yonago-shi (JP)

Correspondence Address: OSTROLENK FABER GERB & SOFFEN, 1180 AVENUE OF THE AMERICAS, NEW YORK, NY, 100368403, US

(21) Appl. No.: 11/572,840

(22) PCT Filed: Mar. 27, 2006
(86) PCT No.: PCT/JP06/06118

§ 371 Date: Sep. 15, 2008

(51) Int. Cl. A23J 3/16; A23L 1/20

(52) U.S. Cl. 426/573

(57) ABSTRACT

2 g of calcium hydroxide are dissolved in 80 cc of hot water having a temperature of 60° C. to prepare a water solution of calcium. 50 g of fibrous soybean protein are added into 150 cc of hot water having a temperature of at 60° C. to prepare a water solution of soybean protein. The water solution of soybean protein is stirred and added 10 g of dried egg, and stirred, then added the water solution of calcium and stirred. 30 g of glucomannan are added into 678 cc of hot water having a temperature of 60° C. to prepare a water solution of glucomannan and stirred to form a jelly-like product. A water solution comprising soybean protein, dried egg and calcium hydroxide is added to the jelly-like product, kneaded and coagulated to form a plate-shaped “Soybean Protein-Glucomannan Jelly”. The plate-shaped “Soybean Protein-Glucomannan Jelly” is minced into small pieces, 3 to 9 mm wide and 3 to 9 mm length, heated at a temperature of 110° C. for 40 minutes to denature them. The small pieces are packed in a retort pouch made from a laminated film comprising a polyester film, an adhesive, an aluminum foil, an adhesive and a high density polyethylene film in this order, degassed, sealed by heat-sealing, and put the heat-sealed retort pouch into an autoclave. Then, sterilization is carried out by increasing the temperature of the center of the heat-sealed retort pouch to 120° C. for 4 minutes.

### BACKGROUND OF THE INVENTION

1. Field of the Invention

The present invention relates to a method of improving the flavor of jelly which is prepared by gelling a soybean protein water solution with glucomannan in the presence of alkaline as a coagulant and has a continuous three-dimensional network structure including discontinuously sol-like liquid phase and method of long-term preservation thereof.

2. Background

Inventors of this invention have invented a composition for a soybean protein-processed food, comprising 5 to 10% of soybean protein, 0.5 to 85 of gelling agent, 0.1 to 0.3% of coagulant and 70 to 90% of water on the basis of total weight of the composition and filed it as a PCT application (PCT/JP2005/013709). And the inventors of this invention obtained the registered trade mark “RECALO” for a composition in which bean-curd tofu lees (okara) is used as soybean protein and devil's tongue jelly (konnyaku) as glucomannan in the invention of PCT/JP2005/013709.

In the present specification, the jelly which is prepared by gelling a soybean protein water solution with glucomannan in the presence of alkaline as a coagulant and has a continuous three-dimensional network structure including discontinuously sol-like liquid phase is referred to as “Soybean Protein-Glucomannan Jelly”.

The “Soybean Protein-Glucomannan Jelly” can be processed in itself to be formed to a hamburger steak, croquette, meat-ball, meat-sauce, etc. containing no meat. The “soybean protein-glucomannan jelly” can be used as a bulking agent or quality modifier for a meat processed-food such as a hamburger steak, croquette, meat-ball, meat-sauce, etc. or paste for a hamburger steak. The “soybean protein-glucomannan jelly” can be processed to prepare an imitation ham or bacon using no pork or imitation pemmican using no beef. The “soybean protein-glucomannan jelly” can be used as a material of dough of bread or cake.

Nutritional interpretations on the “Soybean Protein-Glucomannan Jelly” and soybean protein as a main component of the “Soybean Protein-Glucomannan Jelly” are given in the specification of application of PCT/JP2005/013709. Nutritional, physicochemical and rheological interpretations on glucomannan are also given in the specification of application of PCT/JP2005/013709. Therefore, they are omitted in the present specification.

In the process of marketing of the “Soybean Protein-Glucomannan Jelly”, inventors of this invention have found that the “Soybean Protein-Glucomannan Jelly” has several defects to be solved.

Glucomannan (devil's tongue jelly) as a main component of the “Soybean Protein-Glucomannan Jelly” is a gelling agent. The “Soybean Protein-Glucomannan Jelly” is gelled with glucomannan (devil's tongue jelly). Accordingly, several properties of the “Soybean Protein-Glucomannan Jelly” are improved as described below:
1. Elasticity and viscosity are drastically increased.
2. Newton's viscosity changes to non-Newton's viscosity.
3. The “Soybean Protein-Glucomannan Jelly” has a yield point and is easy to chew.
   That is to say, the viscosity and elasticity of “coagulating properties”, “viscosity”, “elasticity” and “stickiness” which are important as texture profile of food can be improved; thereby easiness to chew is improved. More concretely, the “Soybean Protein-Glucomannan Jelly” is not too soft and not too hard, and has improved elasticity and viscosity and chewy mouth sensation similar to those which are obtained when chewing meat.

Glucomannan (devil's tongue jelly) has properties: (1) gelling properties, (2) thickening and stabilizing properties, (3) moisture retention, (4) film-forming properties, (5) foam uniformly dispersing properties, (6) crystal generation-inhibiting properties, (7) integrity, (8) protein-quality maintaining and improving properties, (9) interaction between polysaccharides (gel strength improving properties, (10) mouth sensation improving properties. Since glucomannan (devil's tongue jelly) contains a large amount of dietary fibers, it is called as “dietary fiber food”.

It has been conventionally thought that glucomannan (devil's tongue jelly) does not contain nutrition at all. However, glucomannan (devil's tongue jelly) contains large amounts of potassium, calcium and dietary fiber. Calcium contained in glucomannan dissolves well in acid and therefore dissolves easily in a stomach and is adsorbed from a small intestine. Dietary fibers contained in glucomannan are water-soluble and have effects of; (1) improvement in the balance of enteric gram negative bacilli, (2) excretion of sodium by virtue of ion exchange action from contents in intestine, (3) excretion of injurious substances in intestine by increasing the amount of faces, and (4) inhibition of excess adsorption of cholesterol and sugar.

Glucomannan is produced from Amorphophallus konjac containing glucomannan as a main component. The term “glucomannan” is also called as “purified powder of devil's tongue jelly”. Accordingly, the term “glucomannan” herein used includes the meaning of “purified powder of devil's tongue jelly”. Glucomannan is polysaccharide in which mannose and glucose are bonded by β1→4 linkage and which has the molecular weight of 1000000˜2000000. The molecule of glucomannan contains trace amounts of acetyl group, uronic acid residue, etc. other than mannose and glucose. A technique for isolating and extracting glucomannan from Amorphophallus konjac has been established. Accordingly, industrial applicability of glucomannan has been widely developed. For example, glucomannan (purified powder of devil's tongue jelly) has been used as a raw material for thin filaments of devil's tongue (devil's tongue noodles), various kinds of desserts or processed foods.

Glucomannan can be gelled irreversibly only by treatment with alkaline as a gelling agent. When glucomannan is treated with alkaline, chemical structural change occurs and an acetyl group bonded as an ester-linkage is eliminated. That is to say, an elimination of acetyl group is indispensable reaction for gelation of glucomannan and a basic measure of completion of gelation (Maeo Kenji; “NOGYO KAGAKU” 52, 251(1978), 52, 485(1978), 52, 513(1978)).

Therefore, the “Soybean Protein-Glucomannan Jelly” contains an alkaline compound such as sodium hydroxide, calcium hydroxide, potassium hydroxide, etc. as an indispensable component. Such an alkaline compound has characteristic smell like soap or bleaching powder.

Accordingly, when the “Soybean Protein-Glucomannan Jelly” is used for a deep-fried food, for example imitation fried chicken and etc., there is a defect that alkaline smell remains unless water contained in the “Soybean Protein-Glucomannan Jelly” is removed completely before it is fried.

By the way, lipid is degraded by oxidation reaction. Oxidation of lipid occurs by not only auto-oxidation, but also action by enzyme, Lipoxidase. Lipoxidase adds an oxygen atom to a fatty acid having a pentadiene structure such as linoleic acid, linolenic acid, arachidonique acid, etc. or esters thereof to produce lipid hydroperoxide. Lipoxidase exists in many plants, and particularly exists abundantly in peas, beans, tomato, eggplant, etc. Volatile aldehyde such as hexanal (caproic aldehyde) which is a decomposition product of lipid hydroperoxide causes discomfort smell of soybean products such as tofu (soybean curd) and etc. Lipoxidase reaction is a phenomenon occurring at the time of

Therefore, the “Soybean Protein-Glucomannan Jelly” containing soybean as a main component has a defect that it generates discomfort smell of soybean in the course of being cooked, processed or preserved.

When block-shaped “Soybean Protein-Glucomannan Jelly” is cooked in a deep-fried food style or marinated grilled meat style, they have a limitation to meat-eating mouth sensation. This is because that 30 to 40% of meat are cross-striated muscle. The cross-striated muscle is a conglomeration comprising elongated muscle fibers having the thickness of 10 to 100μ and the length of about 1 to 5 cm, plasma filled therein and an elastic, transparent and thin film covering the surface thereof.

On the other hand, the “Soybean Protein-Glucomannan Jelly” is jelly which is prepared by gelling a soybean protein water solution with glucomannan in the presence of alkaline as a coagulant and has a continuous three-dimensional network structure including discontinuously sol-like liquid phase. Therefore, the structure of the “Soybean Protein-Glucomannan Jelly” is essentially different from that of meat. When the “Soybean Protein-Glucomannan Jelly” is compared with only glucomannan, texture of the “Soybean Protein-Glucomannan Jelly” is near that of meat.

An interpretation on texture is given below: The origin of “texture” is a fabric, touch, feel, configuration, conformation, etc. which means mainly physical properties. In the field of foods, the “texture” is a general term which means properties evaluated by sensation obtained by a hand or mouth such as “feel or sensation on the teeth”, “smooth”, “feel or sensation on the tongue”, etc.

More detailed interpretation on texture is given below:
(1) Dynamic primary characteristics include harness, agglutinative properties, viscosity, elasticity and adherence. Agglutinative properties as dynamic secondary characteristics include brittleness, chewing properties and gum properties. In “hardness”, there are three stages, that is to say, “soft” “tough” and “hard”. In “brittleness”, there are three stages, that is to say, “crumbled”, “crispy” and “easy to crack”. In “chewing properties”, there are three stages, that is to say, “soft and flexible” “hard to chew” and “tough”. In “gum properties”, there are four stages, that is to say, “easy to crumble” “covered with powdery bloom” “glue like” and “gum like”. In “viscosity”, there are two stages, that is to say. “dry and powdery” and “sticky”. In “elasticity”, there are two stages, that is to say, “plasticity” and “elasticity”. In “adherence”, there are two stages, that is to say, “sticky” and “tacky”.
(2) Geometric characteristics include the size and shape of a particle and the shape and directional property of a particle. As a general description for the size of particle, there are such descriptions as “sand-like” “particle-like” or “grain-like”. As a general description for the shape and directional property of a particle, there are such descriptions as “fiber-like” “cell-like” or “crystal-like”
(3) Another primary characteristics include “water contents” and “fat contents.” As a general description for “water contents”, there are such descriptions as “dry” “moist” “wet” and “watery”. As a general description for “fat contents”, there are such descriptions as “fatty” “greasy” and “oily”.

Main components of the “Soybean Protein-Glucomannan Jelly” are soybean protein and glucomannan. Without glucomannan, the “soybean protein jelly” is crumbled and is lacking in cohesiveness; dry and powdery and is lacking in stickiness; and is lacking in elasticity. By the use of glucomannan as a gelling agent, the “coagulating properties” “viscosity” “elasticity” and “stickiness” which are important as texture profile of food are improved. This is because that glucomannan has the most excellent gelling function, a large amount of dietary fibers and can be ingested. It is true that the texture of the “Soybean Protein-Glucomannan Jelly” is good when it is compared with soybean protein only or glucomannan only. Needless to say, however, the texture of the “Soybean Protein-Glucomannan Jelly” is not good when it is compared with meat.

As described above, the “Soybean Protein-Glucomannan Jelly” has defects caused by soybean protein as a raw material, alkaline used as a coagulant and structure. The defect caused by soybean protein is discomfort smell by volatile aldehyde such as hexanal (caproic aldehyde). Such volatile aldehyde is a decomposition product of lipid hydroperoxide generated by the enzyme reaction of lipoxidase containing in soybeans with a fatty acid having a pentadiene structure such as linoleic acid, linolenic acid, arachidonique acid, etc. or esters thereof.

The defect caused by structure is that the “Soybean Protein-Glucomannan Jelly” contains alkaline in its liquid phase. This is because that the “Soybean Protein-Glucomannan Jelly” is prepared by gelling a water solution of soybean protein with glucomannan in the presence of alkaline as a coagulant and has a continuous three-dimensional network structure including discontinuously sol-like liquid phase.

When the “Soybean Protein-Glucomannan Jelly” is cooked with a fatty acid having a pentadiene structure such as linoleic acid, linolenic acid, arachidonique acid, etc. or esters thereof, it is preferable to remove such alkaline-containing water from the “Soybean Protein-Glucomannan Jelly” as much as possible previously before cooking. The “Soybean Protein-Glucomannan Jelly” is manufactured and sold in the shape of plate. A purchaser usually compresses or taps the “Soybean Protein-Glucomannan Jelly” to remove alkaline-containing water and cuts it before cooking. It is, however, impossible to remove alkaline-containing water completely from three-dimensional network structure only by compressing or tapping the plate-shaped “Soybean Protein-Glucomannan Jelly”.

In order to solve this problem, the inventors of this invention have tried to mince the “Soybean Protein-Glucomannan Jelly” into small pieces having width of 3 to 10 mm and length of 3 to 10 mm; further the inventors of this invention have tried to prepare paste having width of 3 mm and below and length of 3 mm and below from the “Soybean Protein-Glucomannan Jelly”. Accordingly, the term “to mince the “Soybean Protein-Glucomannan Jelly” herein used is defined as that the “Soybean Protein-Glucomannan Jelly” is minced into small pieces having width and length of 3 to 10 mm, respectively. The term “paste” herein used is defined as that the “Soybean Protein-Glucomannan Jelly” cut into small pieces having width and length of 3 mm and below, respectively.

By mincing the “Soybean Protein-Glucomannan Jelly” or cutting it into the shape of paste, it is possible to give a variety of internal structures to the “Protein-Glucomannan Jelly”. Accordingly, the texture of the “Protein-Glucomannan Jelly” can be improved than that obtained when the “Protein-Glucomannan Jelly” is cooked in the shape of block. Further, by mincing the “Soybean Protein-Glucomannan Jelly” or cutting it into the shape of paste, three-dimensional network structure of the “Protein-Glucomannan Jelly” is broken, and thereby alkaline-containing water in the three-dimensional network structure can be completely removed. As a result, discomfort smell of soybeans disappears; and flavor soaks through the entire of the “Soybean Protein-Glucomannan Jelly” to improve the taste because the total surface area is extremely increased rather than that of a block having the same weight.

However, the inventors of this invention have found that there occur such defects as described below by mincing the “Soybean Protein-Glucomannan Jelly” or cutting it into the shape of paste:

since the “Soybean Protein-Glucomannan Jelly” has been conventionally packed in a bag, sealed and heated to be coagulated, the alkalinity inside the three-dimensional network structure is high, that is, in the range within pH 9.5 to 10.5. Accordingly, stabilization effect can be obtained by virtue of alkaline which is a defect from the view point of cooking and can be preserved for three months in a refrigerator. A plate-shaped “Soybean Protein-Glucomannan Jelly” is excellent in stability because its surface are is small compared with its volume. However, the stabilization effect is lost by breaking the three-dimensional network structure of the “Soybean Protein-Glucomannan Jelly” to remove completely alkaline-containing water. As a result, storage life is about one seven days. When minced or paste of the “Soybean Protein-Glucomannan Jelly” is preserved in the environment of liquid, the minced or paste of the “Soybean Protein-Glucomannan Jelly” becomes the state of suspension gradually with time and absorbs a large amount of water, and thereby decreasing meat-eating mouth sensation. This is a serious defect.

In order to solve this defect, the inventors of this invention have studied freezing-preservation of the minced or paste of the “Soybean Protein-Glucomannan Jelly”. However, the minced or paste of the “Soybean Protein-Glucomannan Jelly” contains about 90% of water. Therefore, about 50 to 70% of water exude from the three-dimensional network structure when the frozen “Soybean Protein-Glucomannan Jelly” is defrosted. That is to say, there is a defect that the yield of freezing-defrost is about 40%. Further, when the minced “Soybean Protein-Glucomannan Jelly” which is not cooked is frozen as it is, there is a defect that it is dissociated and crumbled after being defrosted. When frozen minced or paste of the “Soybean Protein-Glucomannan Jelly” which is not cooked is defrosted, discomfort smell of bean-curd tofu lees as raw materials for soybean protein is generated. Further, a repeating step including steps of freezing and defrost increases the total cost, which is not preferable from the view point of merchandizing and marketing.

A food using soybean curd (tofu) or bean-curd tofu lees as a main material has been conventionally proposed. For example, Literature No. 1 discloses a method of preparing a food material, comprising steps of (1) kneading powder of devil's tongue jelly in hot water to prepare jelly, (2) adding an egg and bean-curd tofu lees to the jelly to prepare a mixture, (3) adding an alkaline solution prepared by dissolving calcium hydroxide in tepid water into the mixture, (4) coagulating the mixture to shape, (5) cutting it into pieces, (6) heating the pieces to remove alkaline and (7) giving meat-eating sensation. However, Literature No. 1 neither describes nor suggests a method of removing discomfort smell of bean-curd tofu lees and devil's tongue and a method of long-term preservation.

Literature No. 2 discloses a processed food prepared by mixing devil's tongue jelly with bean-curd tofu lees or peas or beans to prepare a mixture, and coagulating the mixture. However, Literature No. 2 neither describes nor suggests a method of removing discomfort smell of bean-curd tofu lees and devil's tongue and a method of long-term preservation.
Literature No. 1: Japanese Registered Patent No. 3498087
Literature No. 2: Unexamined Patent Application, Laying-open No. 10-52233

### DISCLOSURE OF INVENTION

### Problems to be Solved by Invention

A first problem to be solved by the invention is to improve the flavor and texture of soybean protein-glucomannan jelly which is prepared by gelling a soybean protein water solution with glucomannan in the presence of alkaline as a coagulant and has a continuous three-dimensional network structure including discontinuously sol-like liquid phase.

A second problem to be solved by the invention is to prevent the generation of discomfort smell of soybean and improve the flavor when cooking the soybean protein-glucomannan jelly which is prepared by gelling a soybean protein water solution with glucomannan in the presence of alkaline as a coagulant and has a continuous three-dimensional network structure including discontinuously sol-like liquid phase with fatty acid having a pentadiene structure such as linoleic acid, linolenic acid, arachidonique acid, etc. or esters thereof.

A third problem to be solved by the invention is to provide a method of prevention of the generation of discomfort smell of soybean comprising; removing completely water included discontinuously in the continuous three-dimensional network structure of the protein-glucomannan jelly which is prepared by gelling a soybean protein water solution with glucomannan in the presence of alkaline as a coagulant and a method of improving the e flavor.

A fourth problem to be solved by the invention is to provide a method of improving the texture of the soybean protein-glucomannan jelly which is prepared by gelling a soybean protein water solution with glucomannan in the presence of alkaline as a coagulant, and which has a continuous three-dimensional network structure including discontinuously sol-like liquid phase, and which is improved not so as to generate discomfort smell of soybeans and alkaline and is to provide a method of long-term preservation thereof.

### Means for Solving the Problems

First, in order to solve the above-described problems, the soybean protein-glucomannan jelly which is prepared by gelling a soybean protein water solution with glucomannan in the presence of alkaline as a coagulant and has a continuous three-dimensional network structure including discontinuously sol-like liquid phase is cut into small pieces.

The term “small piece” herein used means mince having width of 3 to 10 mm and length of 3 to 10 mm or paste having width of 3 mm and below and length of 3 mm and below, but is not restricted thereto.

In order to mince the plate-shaped “Soybean Protein-Glucomannan Jelly”, a silent cutter, chopper, etc. for food processing is used. In order to prepare paste from the plate-shaped “Soybean Protein-Glucomannan Jelly”, a masher for food processing is used.

By cutting the plate-shaped “Soybean Protein-Glucomannan Jelly” into such small pieces as mince or paste, alkaline-containing water included in the continuous three-dimensional network structure of the “Protein-Glucomannan Jelly” is removed completely. Accordingly, the generation of discomfort smell of alkaline can be prevented when the “Soybean Protein-Glucomannan Jelly” is cooked or preserved.

On the other hand, the generation of discomfort smell caused by soybean protein as a raw material of the “Soybean Protein-Glucomannan Jelly” can not be prevented only by cutting the plate-shaped “Soybean Protein-Glucomannan Jelly” into such small pieces as mince or paste. In order to prevent the generation of discomfort smell caused by soybean protein, it is necessary that the plate-shaped “Soybean Protein-Glucomannan Jelly” is cut into such small pieces as mince or paste and heating at 100 to 110° C. for 30 to 60 minutes and to deactivate an enzyme, lipoxidase which is contained in soybean protein and causes discomfort smell.

The time to heat the “Soybean Protein-Glucomannan Jelly” of 30 minutes and below and the heating temperature of the “Soybean Protein-Glucomannan Jelly” of 100° C. and below are not preferable. This is because that the deactivation of an enzyme, lipoxidase is insufficient, the “Soybean Protein-Glucomannan Jelly” can not be cooked completely, thermal change of the “Soybean Protein-Glucomannan Jelly” is not sufficient and cooking time at a post-process can not be shortened. Conversely, the time to heat the “Soybean Protein-Glucomannan Jelly” of one hour and above and the heating temperature of the “Soybean Protein-Glucomannan Jelly” of 100° C. and above are not preferable. This is because that the “Soybean Protein-Glucomannan Jelly” is denatured in excess and mouth sensation of “hard” as dynamic secondary characteristics of texture changes from “tough” to “hard”.

By cutting the “Soybean Protein-Glucomannan Jelly” into such small pieces as mince or paste, and heating at temperatures of from 100 to 110° C. for 30 to 60 minutes, discomfort smell of soybeans and alkaline of the “Soybean Protein-Glucomannan Jelly” is not generated and taste and texture are improved. There is, however, a defect that bactericidal effect of alkaline disappears, thereby making long-term preservation impossible.

In order to solve the above-described defect, it is preferable to cut the “Soybean Protein-Glucomannan Jelly” into such small pieces as mince or paste, heating such small pieces at temperatures from 100 to 110° C. for 30 to 60 minutes to stop the generation of discomfort smell of soybeans and alkaline, packing such small pieces into a light-shielding and hermetically sealed container and subjecting such small pieces to sterilization under pressurization and heating.

As a container into which such small pieces are packed, a metal-made can, a glass-made bottle, a plastics-made container, a container made from a laminated film comprising a plastics film and a metal foil, etc. are used. However, a retort pouch or tray is preferably used from the view point of merchandizing or easiness to use.

As a retort container, a container authorized under JAS (Japanese Agricultural Standard) and FSL (Food Sanitation Law) is used. For example, a pouch made from laminated film comprising a polyester film, an adhesive, an aluminum foil, an adhesive and a high density polyethylene or polyester film in this order is preferably used.

Alternatively, instead of a pouch, a tray made from a laminated film comprising an external protecting film, a 100 μm-thick aluminum foil and a 50 μm-thick polypropylene film in this order; a knife-cut type tray made from a laminated film comprising a 50 μm-thick polypropylene film, 100 to 150 μm-thick aluminum foil and an external protecting film in this order; an easy-to open type tray made from a laminated film comprising an external protecting film, a 50 μm-thick aluminum foil, 15 to 20 μm-thick polypropylene film in this order; an easy-to open type tray made from a laminated film comprising a 50 μm-thick polypropylene film, 100 to 150 μm-thick aluminum foil and an external protecting film in this order are preferably used.

Accordingly, the afore-mentioned problems are solved by the following means:
1. A method of improving flavor and texture of jelly which is prepared by gelling a water solution of soybean protein with glucomannan in the presence of alkaline as a coagulant and has a continuous three-dimensional network structure including discontinuously sol-like alkaline-containing water; comprising steps of;
(1) cutting the jelly which is prepared by gelling a water solution of soybean protein with glucomannan in the presence of alkaline as a coagulant and has a continuous three-dimensional network structure including discontinuously sol-like alkaline-containing water into small pieces; and
(2) heating the jelly in the shape of small pieces at temperatures of 100 to 110° C. for 30 to 60 minutes to denature the jelly for edibility and to deactivate lipoxidase contained in soybean protein for prevention of generation of discomfort smell of soybean and removing forcedly alkaline-containing water contained in the three-dimensional network structure for prevention of generation of discomfort smell of alkaline.

2. A method of improving flavor, texture and long-term preservation of jelly which is prepared by gelling a water solution of soybean protein with glucomannan in the presence of alkaline as a coagulant and has a continuous three-dimensional network structure including discontinuously sol-like alkaline-containing water; comprising steps of;
(1) cutting the jelly which is prepared by gelling a water solution of soybean protein with glucomannan in the presence of alkaline as a coagulant and has a continuous three-dimensional network structure including discontinuously sol-like alkaline-containing water into small pieces; and
(2) heating the jelly in the shape of small pieces at temperatures of 100 to 110° C. for 30 to 60 minutes to denature the jelly for edibility and to deactivate lipoxidase contained in soybean protein for prevention of generation of discomfort smell of soybean and removing forcedly alkaline-containing water contained in the three-dimensional network structure for prevention of generation of discomfort smell of alkaline; and
(3) packing the jelly the flavor and texture of which are improved at the previous steps into a light-shielding and oxygen-non-permeable container, degassing, sealing hermetically and subjecting to sterilization under pressurization and heating.

### Effect of the Invention

According to the invention described in claim 1, effects illustrated below can be obtained:
1. Since the “Soybean protein-Glucomannan Jelly” is cut into small pieces, sol-like alkaline-containing water contained in the three-dimensional network structure is completely removed and thereby discomfort smell of alkaline is not generated.

2. Since the “Soybean protein-Glucomannan Jelly” is cut into small pieces and then heated at temperatures from 100 to 110° C. for 30 to 90 minutes, an enzyme, lipoxidase, contained in soybean protein is deactivated, it is therefore possible to prevent the generation of discomfort smell of soybean protein.

3. Since the “Soybean protein-Glucomannan Jelly” is heated at temperatures from 100 to 110° C. for 30 to 90 minutes, it is denatured so as to be edible, and cooking time at a next step is shortened.

4. Alkaline-containing water contained in the three-dimensional network structure is removed forcedly, thereby making it possible to prevent completely the generation of discomfort smell of alkaline.

5. The “Soybean protein-Glucomannan Jelly” is cut into small pieces and heated at temperatures from 100 to 110° C. for 30 to 90 minutes to stop completely the generation of discomfort smell of soybean and alkaline and is previously cooked so as to eat. Accordingly, taste and texture can be improved compared with cooking a block-shaped “Soybean protein-Glucomannan Jelly”.

According to the invention described in claim 2, effects illustrated below can be obtained:
1. Long-term preservation of the “Soybean protein-Glucomannan Jelly” can not be maintained only by cutting the “Soybean protein-Glucomannan Jelly” into such small pieces as mince or paste and heating at temperatures from 100 to 110° C. for 30 to 90 minutes. However, long-term preservation of the “Soybean protein-Glucomannan Jelly” can be maintained by packing such mince or paste-like jelly that has been heated at temperatures from 100 to 110° C. for 30 to 90 minutes into a light-shielding and oxygen-non-permeable container, degassing, sealing hermetically and subjecting to sterilization under pressurization and heating.

By the use of a retort pouch or tray made from a laminated film comprising a plastics film and a metal foil as a container, various kinds of merits are obtained from the view point of merchandising or marketing.

### MOST PREFERRED EMBODIMENT FOR CARRYING OUT INVENTION

Most preferred embodiments for carrying out the invention will be described below with reference to examples.

### Example 1

### Production of “Soybean Protein-Glucomannan Jelly”

Step 1: A water solution of calcium was previously prepared by dissolving 2 g of calcium hydroxide as a coagulant in 80 cc of hot water having a temperature of 60° C.

Step 2: Independently from the Step 1, a water solution of soybean protein was prepared by adding 50 g of fibrous soybean protein manufactured by AJINOMOT CO. LTD. under the trade mark “PROTEX FA” into 150 cc of hot water having a temperature of 60° C. The water solution of soybean protein thus obtained was vigorously stirred and 10 g of dried egg as binding agent were added thereto, and stirred, then was added the water solution of calcium prepared in the Step 1, and vigorously stirred.

Step 3: A water solution of a gelling agent was prepared by adding 30 g of glucomannan into 678 cc of hot water having a temperature of 60° C. and vigorously stirred to form a jelly-like product. A water solution comprising soybean protein, dried egg and calcium hydroxide prepared in the Step 2 was added to the jelly-like product, vigorously kneaded and coagulated to form a plate-shaped “Soybean Protein-Glucomannan Jelly” having thickness of 10 cm, length of 60 mm and width of 60 mm.

Then, the plate-shaped “Soybean Protein-Glucomannan Jelly” thus prepared was minced into small pieces having the width of 3 to 9 mm and length of 3 to 9 mm, heated at a temperature of 110° C. for 40 minutes to denature them for being fit to be eaten. Then, thus treated small pieces were packed in a retort pouch made from a laminated film comprising a polyester film, an adhesive, an aluminum foil, an adhesive and a high density polyethylene film in this order, degassed, sealed by heat-sealing, and put the heat-sealed retort pouch into an autoclave. Then, sterilization was carried out by increasing the temperature of the center of the heat-sealed retort pouch to 120° C. for four minutes and above in the autoclave.

[Sensory Test-Routine Test]

Each of 100 members of panelist having analyzing abilities was isolated. Smoking, gum and lipstick were prohibited within 30 minutes before the test. Lighting, room temperatures and air ventilation in each of testing rooms were under the same conditions, respectively.

[Sensory Test for Alkaline Discomfort Smell]

The plate-shaped “Soybean Protein-Glucomannan Jelly” prepared in Example 1 was minced into small pieces having the width of 3 to 9 mm and length of 3 to 9 mm, heated at a temperature of 110° C. for 40 minutes to denature them for being fit to be eaten. During this cooking process, each of 100 panelists confirmed that alkaline discomfort smell was not generated.

[Sensory Test for Soybean Discomfort Smell]

Then, the minced small pieces prepared in Sensory Test for alkaline discomfort smell were deep-fried in high oleic acid-containing safflower oil. During this cooking process, each of 100 panelists confirmed that soybean discomfort smell was not generated.

[Comparative Test 1]

In the face of each of 100 panelists, the plate-shaped “Soybean Protein-Glucomannan Jelly” prepared in Example 1 was cut into blocks having the thickness of 10 cm, width of 30 mm and length of 30 mm. During this cutting process, alkaline-containing water was oozed from cutting faces. Each of 100 panelists confirmed that alkaline discomfort smell was generated.

Then, the blocks prepared in Comparative Test 1 for alkaline discomfort smell were deep-fried in high oleic acid-containing safflower oil. During this cooking process, each of 100 panelists confirmed that soybean discomfort smell was generated.

### Example 2

### Texture Test

The plate-shaped “Soybean Protein-Glucomannan Jelly” having the thickness of 10 mm, width of 60 mm and length of 60 mm prepared in Example 1 was formed into paste having the width of 3 mm and below and length of 3 and below, heated them at a temperature of 110° C. for 40 minutes to denature them for being fit to be eaten. Then, the paste thus obtained was formed into the shape of oval having the long diameter of 60 mm and short diameter of 30 mm, and browned with high oleic acid-containing safflower oil without food materials, food additives and seasonings to prepare 100 pieces of imitation hamburger steaks for 100 panelists.

[Comparative Test 2]

The plate-shaped “Soybean Protein-Glucomannan Jelly” having the thickness of 10 mm, width of 60 mm and length of 60 mm prepared in Example 1 was formed, as it is, into the shape of oval having the long diameter of 60 mm and short diameter of 30 mm, and browned with high oleic acid-containing safflower oil without food materials, food additives and seasonings to prepare 100 portions of imitation hamburger steaks for 100 panelists.

[Sensory Test-Routine Test]

Each of 100 members of panelist having analyzing abilities was isolated. Smoking, gum and lipstick were prohibited within 30 minutes before the test. Lighting, room temperatures and air ventilation in each of testing rooms were under the same conditions, respectively.

First, visual inspection of the imitation hamburger steaks prepared in Example 2 and Comparative Example 2 was carried out. As a result, 50 panelists confirmed muscle-like strings on the surface of the imitation hamburger steaks of Example 2 and judged that the imitation hamburger steaks of Example 2 resemble real meat. The remaining 50 panelists judged that the imitation hamburger steaks of Example 2 are not distinguished from the imitation hamburger steaks of Comparative Example 2 in appearances.

[Hardness Test]

Next, 100 portions of the imitation hamburger steaks of Example 2 were prepared as reference standards for “hardness test”. Comparative Example 2 was repeated 200 times to prepare 200 samples. One reference standard and two samples were given to each of 100 panelists, and hardness tests were carried out. In this case, eating order was random in consideration of effect by order of eating; center and both ends were exchanged in consideration of effect by position. 60 panelists judged that imitation hamburger steaks of Example 2 are “soft”. Remaining 40 panelists evaluated that imitation hamburger steaks of Example 2 are “tough”. On the other hand, 100 panelists evaluated that imitation hamburger steaks of Comparative Example 2 are “hard to eat”.

[Chewing Test]

Next, according to the similar procedures to that of “Hardness Test”, “Chewing Test” was carried out. 100 panelists evaluated that imitation hamburger steaks of Example 2 are “soft and flexible”. On the other hand, 100 panelists evaluated that imitation hamburger steaks of Comparative Example 2 are “hard to chew”.

[Size, Shape and Directional Property of Particles]

Next, imitation hamburger steaks of Example 2 and Comparative Example 2 were inspected by a 400-power microscope. As a result, it was observed that the imitation hamburger steaks of Example 2 are composed of fine and round particles which have various types of shapes. On the other hand, it was observed that the imitation hamburger steaks of Comparative Example 2 are composed of thick fibrous network structures and it was observe that polyhedral spherical particles having a size 2 to 5 times as large as that of Example 2 exist between such thick fibrous network structures.

[Shelf Life Test]

80 pieces of retort pouch-packed food were prepared according to Example 1 and preserved in a safe at a room temperature for two years at a maximum. The retort pouch-packed foods were taken out of the safe by 10 pieces and unsealed. And, color, taste, deterioration by microorganisms, loss in function, etc. were checked according to IFT (Institute of Food Technology). No change was observed between results obtained at an initial day and those obtained two years later.

“Soybean protein-Glucomannan Jelly” was taken out of the safe by 10 pieces per every three months over two years, cooked in such a manner as that of Example 1 to prepare 80 pieces of cooked products. Sensory tests, texture tests, etc were carried out to 80 pieces of cooked products thus prepared in such a manner as those of Example 1. Same results as those of Example 1 were obtained for all of 80 pieces of cooked products.

### INDUSTRIAL APPLICABILITY

According to this invention, there is provided a method of improving flavor and texture of jelly which is prepared by gelling a water solution of soybean protein with glucomannan in the presence of alkaline as a coagulant and has a continuous three-dimensional network structure including discontinuously sol-like alkaline-containing water; comprising steps of; (1) cutting the jelly which is prepared by gelling a water solution of soybean protein with glucomannan in the presence of alkaline as a coagulant and has a continuous three-dimensional network structure including discontinuously sol-like alkaline-containing water into small pieces; and(2) heating the jelly in the shape of small pieces at temperatures of 100 to 110° C. for 30 to 60 minutes to denature the jelly for edibility and to deactivate lipoxidase contained in soybean protein for prevention of generation of discomfort smell of soybean and removing forcedly alkaline-containing water contained in the three-dimensional network structure for prevention of generation of discomfort smell of alkaline. Therefore, this invention can be applied not only for business purpose, but also for household purpose.

According to this invention, there is provided a method of improving flavor, texture and long-term preservation of jelly which is prepared by gelling a water solution of soybean protein with glucomannan in the presence of alkaline as a coagulant and has a continuous three-dimensional network structure including discontinuously sol-like alkaline-containing water; comprising steps of; (1) cutting the jelly which is prepared by gelling a water solution of soybean protein with glucomannan in the presence of alkaline as a coagulant and has a continuous three-dimensional network structure including discontinuously sol-like alkaline-containing water into small pieces; (2) heating the jelly in the shape of small pieces at temperatures of 100 to 110° C. for 30 to 60 minutes to denature the jelly for edibility and to deactivate lipoxidase contained in soybean protein for prevention of generation of discomfort smell of soybean and removing forcedly alkaline-containing water contained in the three-dimensional network structure for prevention of generation of discomfort smell of alkaline; and (3) packing the jelly the flavor and texture of which are improved at the previous steps into a light-shielding and oxygen-non-permeable container, degassing, sealing hermetically and subjecting to sterilization under pressurization and heating. Therefore, this invention has a variety of advantages from a view point of merchandizing and marketing and has the possibility of creation of novel market.

1-2. (canceled)

3. A method of improving flavor, texture and long-term preservation of jelly which is prepared by gelling a water solution of soybean protein with glucomannan in the presence of alkaline as a coagulant and the jelly has a continuous three-dimensional network structure including discontinuously sol-like alkaline-containing water; comprising steps of:
(1) cutting said jelly into small pieces, which is prepared by gelling a water solution of soybean protein with glucomannan in the presence of alkaline as a coagulant and has a continuous three-dimensional network structure including discontinuously sol-like alkaline-containing water; and
(2) washing and dewatering the cut small pieces of jelly obtained in the preceding step (1) to remove the alkaline-containing water contained in the three-dimensional network structure for prevention of generation of a smell of alkaline; and
(3) packing the cut small pieces of jelly obtained in the preceding step (2) in a pressure-heat resistant and oxygen-impermeable container, degassing, sealing hermetically and pressurizing and heating, thereby carrying out sterilization and heat-degeneration of said jelly for edibility and deactivating lipoxidase contained in soybean protein for prevention of generation of discomfort smell of soybean.

4. The method described in claim 3, wherein the small pieces have a shape that is mince, paste or shreds.

5. The method described in claim 3, wherein the pressure-heat resistant and oxygen-impermeable container is a retort pouch.

6. The method described in claim 4 wherein the pressure-heat resistant and oxygen-impermeable container is a retort pouch.
